(19) United States
(12) Patent Application Publication
(10) Pub. No.: US 2026/0361493 A1
(43) Pub. Date: Nov. 12, 2026

(54) LIGHT ADAPTATION FOR REDUCED CHANNEL STATE INFORMATION CONFIGURATIONS

(71) Applicant: QUALCOMM Incorporated, San Diego, CA (US)

(72) Inventors: Diana MAAMARI, San Diego, CA (US); Gabi SARKIS, San Diego, CA (US); Muhammad Sayed Khairy ABDELGHAFFAR, San Jose, CA (US); Yu ZHANG, San Diego, CA (US)

(21) Appl. No.: 19/205,958

(22) Filed: May 12, 2025

(51) Int. Cl. H04L 5/00; H04W 24/10

(52) U.S. Cl. CPC H04L 5/0051; H04W 24/10

(57) ABSTRACT

This disclosure provides methods, components, devices, and systems for light adaptation for reduced channel state information (CSI) configurations. A user equipment (UE) may receive a CSI report configuration indicating sub-configurations associated with adaptation techniques supported by a network entity. The UE may receive control signaling activating a sub-bandwidth part (sub-BWP) of a bandwidth for evaluating CSI. In some examples, the UE may receive one or more CSI reference signals via the activated sub-BWP for evaluating CSI. The UE may transmit a joint CSI report that includes one or more sub-reports based on the CSI report configuration and in accordance with the activated sub-BWP. In some examples, the UE may determine which sub-reports to include in the joint CSI report based on an association between the activated sub-BWP and each reporting sub-configuration included in the CSI reporting configuration.

### TECHNICAL FIELD

This disclosure relates generally to wireless communication, and more specifically to systems, devices, methods, and techniques associated with light adaptation for reduced channel state information configurations.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving first control information that indicates a channel state information (CSI) report configuration corresponding to a bandwidth part, receiving second control information, after receiving the first control information, that indicates a sub-bandwidth part of the bandwidth part, and transmitting, based on receiving the first control information and the second control information, a CSI report in accordance with a sub-configuration of the CSI report configuration corresponding to the bandwidth part, the sub-configuration corresponding to the sub-bandwidth part of the bandwidth part.

A UE for wireless communications is described. The UE may include a processing system that includes processor circuitry and memory circuitry that stores code. The processing system may be configured to cause the UE to receive first control information that indicates a CSI report configuration corresponding to a bandwidth part, receive second control information, after receiving the first control information, that indicates a sub-bandwidth part of the bandwidth part, and transmit, based on receiving the first control information and the second control information, a CSI report in accordance with a sub-configuration of the CSI report configuration corresponding to the bandwidth part, the sub-configuration corresponding to the sub-bandwidth part of the bandwidth part.

Another UE for wireless communications is described. The UE may include means for receiving first control information that indicates a CSI report configuration corresponding to a bandwidth part, means for receiving second control information, after receiving the first control information, that indicates a sub-bandwidth part of the bandwidth part, and means for transmitting, based on receiving the first control information and the second control information, a CSI report in accordance with a sub-configuration of the CSI report configuration corresponding to the bandwidth part, the sub-configuration corresponding to the sub-bandwidth part of the bandwidth part.

A non-transitory computer-readable medium storing code for wireless communications is described. The code may include instructions executable by one or more processors to receive first control information that indicates a CSI report configuration corresponding to a bandwidth part, receive second control information, after receiving the first control information, that indicates a sub-bandwidth part of the bandwidth part, and transmit, based on receiving the first control information and the second control information, a CSI report in accordance with a sub-configuration of the CSI report configuration v the bandwidth part, the sub-configuration corresponding to the sub-bandwidth part of the bandwidth part.

In some examples of the method, UEs, and non-transitory computer-readable medium described herein, the CSI report configuration may correspond to a set of channel state information reference signal (CSI-RS) resources corresponding to the bandwidth part and the method, apparatuses, and non-transitory computer-readable medium may include further operations, features, means, or instructions for receiving, based on the second control information, a set of one or more CSI-RSs using a subset of the CSI-RS resources, the subset of the CSI-RS resources corresponding to the sub-bandwidth part and transmitting the CSI report based on receiving the set of one or more CSI-RSs using the subset of the CSI-RS resources.

In some examples of the method, UEs, and non-transitory computer-readable medium described herein, the CSI report configuration includes a set of multiple sub-reports each corresponding to a respective sub-bandwidth part of the bandwidth part; and the CSI report may be a sub-report of the set of multiple sub-reports that corresponds to the sub-bandwidth part based on the second control information that indicates the sub-bandwidth part.

### BRIEF DESCRIPTION OF THE DRAWINGS

FIG. 1 shows an example of a wireless communication system.

FIG. 2 shows an example of a signaling configuration that supports light adaptation for reduced CSI configurations.

FIG. 3 shows an example of a signaling configuration that supports light adaptation for reduced CSI configurations.

FIG. 4 shows an example of a process flow that supports light adaptation for reduced CSI configurations.

FIG. 5 shows a block diagram of a processing system that supports light adaptation for reduced CSI configurations.

FIG. 6 shows a diagram of a system including a device that supports light adaptation for reduced CSI configurations.

FIG. 7 shows a flowchart illustrating methods that support light adaptation for reduced CSI configurations.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, wireless devices may support communicating channel state information (CSI) to determine parameters for communications. For example, a user equipment (UE) may transmit a CSI report to a network entity based on measurements of one or more CSI reference signals (CSI-RS). The network entity may support one or more techniques for antenna adaptation in accordance with operating in a NES mode. For example, the network entity may be configured to implement Type 1 spatial-domain (SD) adaptation, Type 2 SD adaptation, power-domain (PD) adaptation, or any combination thereof. In such examples, the network entity may configure the UE to transmit a joint CSI report including one or more sub-reports that correspond to respective adaptation techniques implemented by the network entity.

In some implementations, a UE may support switching between frequencies for communicating with a network entity. For example, a UE may support light adaptation, for which the UE is configured with a bandwidth part (BWP) including a wideband sub-bandwidth part (sub-BWP) and a narrowband sub-BWP that correspond to respective power states of the UE. A UE may switch between a first power state (e.g., the first sub-BWP) and a second power state (e.g., the second sub-BWP) based on dynamic signaling. However, some techniques for reporting channel state feedback (CSF) may not support a joint CSI report that accounts for adaptation techniques implemented by a network entity and light adaptation at a UE.

Various aspects of the present disclosure are related to light adaptation for reduced CSI configurations. In some examples, a UE may receive a CSI report configuration indicating multiple reporting sub-configurations that each correspond to a respective type of adaptation technique supported by a network entity. The UE may receive additional signaling activating one of a plurality of sub-BWPs of a bandwidth for evaluating CSI. In some examples, the UE may receive one or more CSI-RSs via the activated sub-BWP for evaluating CSI. The UE may transmit a joint CSI report that includes one or more sub-reports based on the CSI report configuration and in accordance with the activated sub-BWP. In some examples, the UE may determine which sub-reports to include in the joint CSI report based on an association (e.g., a correspondence, a configuration) between the activated sub-BWP and each reporting sub-configuration included in the CSI reporting configuration. For example, fewer than all of the reporting sub-configurations may be considered valid for the activated sub-BWP of the UE. Accordingly, the joint CSI report may include sub-reports corresponding to the valid reporting sub-configurations for the activated sub-BWP, which may be implemented in accordance with reduced configuration or signaling overhead.

Particular aspects of the subject matter described in this disclosure can be implemented to realize one or more of the following potential advantages. In some examples, by generating joint CSI reports based on associations between UE sub-BWPs and NES adaptation techniques, the described techniques can be used to extend a CSI reporting framework to support sub-reports based on sub-BWPs configured for UE light adaptation in addition to network entity antenna adaptation using a single CSI reporting configuration, which may reduce signaling overhead and latency.

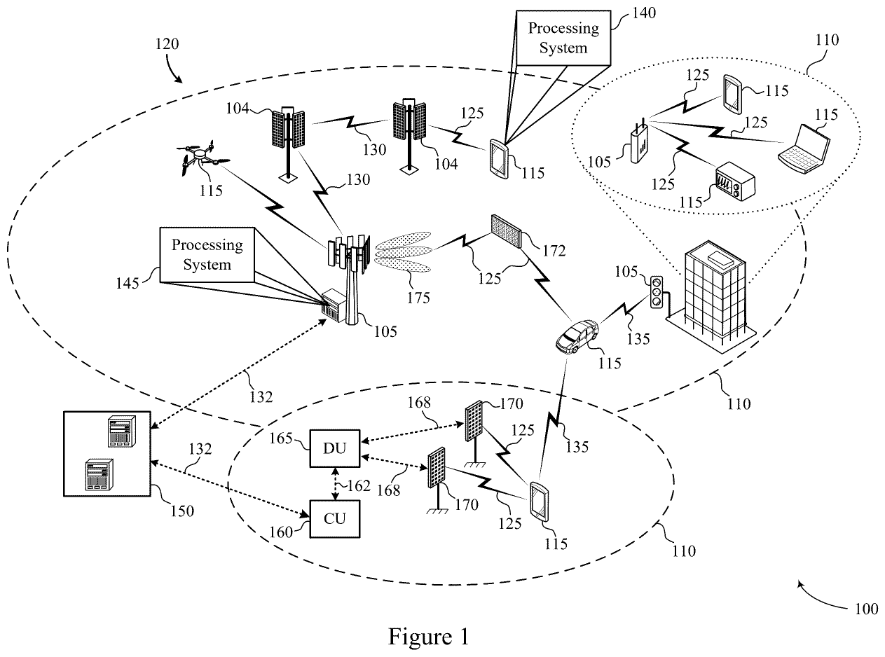

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaptation Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for light adaptation for reduced CSI configurations. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support communication of a joint CSI report based on sub-BWPs configured for UE light adaptation and network entity antenna adaptation using a single CSI reporting configuration, which may reduce signaling overhead and latency.

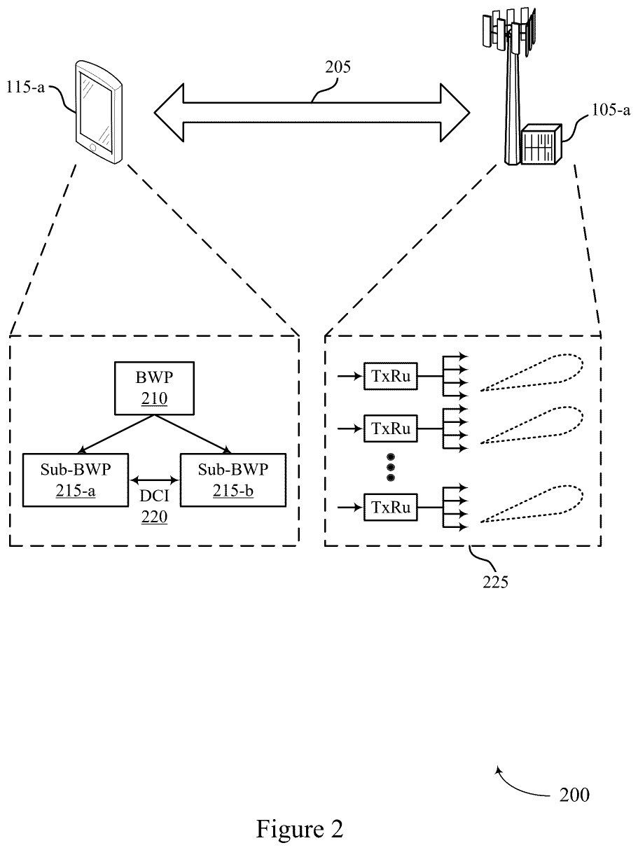

FIG. 2 shows an example of a signaling configuration 200 that supports light adaptation for reduced CSI configurations. The signaling configuration 200 may implement, or be implemented by, aspects of the wireless communication system 100. For example, the UE 115-a and the network entity 105-a may be examples of corresponding devices described with reference to FIG. 1. The UE 115-a and the network entity 105-a may communicate via a communication link 205, which may be an example of a cellular link (such as a communication link 125).

In some wireless communications systems, adaptation of one or more parameters (e.g., wireless communication parameters) over time may improve wireless communications between network devices. For example, time adaptation, frequency adaptation, antenna adaptation, and other types of adaptation may save energy at the UE 115-a and the network entity 105-a, or improve power conservation or communication reliability at the UE 115-a and the network entity 105-a, among other examples.

In some examples, the UE 115-a may be configured to switch between BWPs 210. For example, the UE 115-a may perform BWP switching to accommodate different configurations for the network entity 105-a. BWP switching at the UE 115-a may be performed using (such as in response to, as a function of) RRC signaling, DCI signaling, or in accordance with timers. However, the UE 115-a may experience out-of-sync (OOS) scenarios, for example, due to missing a switching DCI (e.g., failing to receive a switching DCI), receiving a false DCI, using a discontinuous transmission configuration (such as associated with a PUSCH), or communicating during a proprietary conflict window, among other examples. For example, the network entity 105-a may switch to a new BWP 210 while the UE 115-a remains in an original BWP 210. In another example, the UE 115-a may switch to the new BWP 210 while the network entity 105-a remains in the original BWP 210. In some cases, switching between a first BWP 210 (e.g., RRC parameters corresponding to the first BWP 210) and a second BWP 210 (e.g., RRC parameters corresponding to the second BWP 210) may involve a reconfiguration (e.g., reprogramming) at the UE, which may be associated with relatively long switching times, relatively large overhead, and increased likelihood of OOS scenarios. This may result in increased latency, failed communications, and poor user experience.

In accordance with examples as disclosed herein, the UE 115-a may be configured to implement light adaptation to support adaptation of parameters (e.g., a bandwidth, a maximum rank, a timeline, a PDCCH monitoring period) over time while reducing the complexity, configuration changes, switching delay, and overhead associated with BWP switching. Light adaptation may include switching between states of a single BWP configuration (e.g., the BWP 210), for which each state may correspond to a different set of parameter values for the BWP configuration. The UE 115-a may be configured with (e.g., allocated) a BWP 210 for communications with the network entity 105-a (e.g., PDCCH, PDSCH, RACH signaling, PUSCH, SRS). The UE 115-a may also be configured with multiple (e.g., two or more) sub-BWPs 215 (e.g., a first sub-BWP 215-a, a second sub-BWP 215-b) of the BWP 210 (e.g., subbands of the BWP 210).

Each sub-BWP 215 may be associated with one or more parameters (e.g., corresponding to the sub-BWP 215), including a bandwidth, a maximum rank, a timeline, a PDCCH monitoring period, a synchronization signal periodicity, or any combination thereof, among other parameters. Each sub-BWP 215 also may correspond to a state (e.g., a power state) of the UE 115-a. For example, a first sub-BWP 215-a may correspond to a first power state (e.g., a high power state) and a second sub-BWP 215-b may correspond to a second power state (e.g., a low power state). The UE 115-a may receive DCI 220 indicating to switch between sub-BWPs 215, and a format size and one or more fields of the DCI 220 may be independent of an active sub-BWP 215.

In some examples, the network entity 105-a may support a NES configuration. In accordance with an NES configuration, the network entity 105-a may support one or more adaptation techniques. For example, the network entity 105-a may support Type1 spatial domain adaptation, for which all antenna elements (AEs) of one or more logical antenna ports at the network entity 105-a may be disabled or enabled. Additionally, or alternatively, the network entity 105-a may support Type2 spatial domain adaptation, for which a subset of AEs corresponding to a logical antenna port may be enabled or disabled. Additionally, or alternatively, the network entity 105-a may support power domain adaptation, for which a transmission power of the network entity 105-a may be adjusted.

The UE 115-a and the network entity 105-a may support channel estimation techniques using one or more CSI-RSs. In some implementations, the network entity 105-a may configure the UE 115-a to perform channel estimation measurements and report measurement results to the network entity 105-a. For example, the UE 115-a may receive control signaling (e.g., first control signaling) indicating a CSI report configuration.

In some examples, such a CSI report configuration may include multiple sub-configurations corresponding to different adaptation techniques supported by the network entity 105-a. For example, the CSI report configuration may include a sub-configuration 225 corresponding to Type1 spatial domain adaptation that indicates an antenna array configuration (e.g., N1, N2, and Ng), a subset of ports to be used for CSI computation, a codebook type, a codebook mode (e.g., for cases in which some sub-configurations are configured with a single-panel codebook type and other sub-configurations are configured with a multi-panel codebook type), a codebook subset restriction, a rank restriction, or any combination thereof. In some other examples, the CSI report configuration may include a sub-configuration 225 corresponding to Type2 spatial domain adaptation that indicates a list of CSI-RS resource identifiers.

Additionally, or alternatively, such a CSI report configuration may include a sub-configuration 225 corresponding to power domain adaptation that indicates an offset value to apply to CSI-RS power offsets or PDSCH power offsets for measurement resources within the CSI-RS resource set. The CSI report configuration may not support simultaneous configuration of both Type1 spatial domain adaptation and Type2 spatial domain adaptation in a same CSI report configuration. However, the CSI report configuration may support joint operation (e.g., joint configuration) for spatial domain adaptation (e.g., Type1, Type2) and power domain adaptation. In such cases, each sub-configuration may indicate a first set of parameters for spatial domain adaptation and a second set of parameters for power domain adaptation.

In some implementations, the UE 115-a may support feedback of multiple CSI indications corresponding to spatial domain adaptation and power domain adaptation in a single CSI report (e.g., a joint CSI report). For example, the UE 115-a may transmit a single CSI report including multiple sub-reports corresponding to one or more sub-configurations 225 (e.g., antenna adaptation sub-configurations) of the network entity 105-a.

However, for cases in which the UE 115-a supports light adaptation and is configured with multiple sub-BWPs 215, it may be beneficial to extend joint CSI reporting to also consider light adaptation sub-configurations for the UE 115-a, in addition to antenna adaptation sub-configurations for the network entity 105-a. Accordingly, various aspects of the present disclosure are related to light adaptation for reduced CSI configurations. In some examples, the UE 115-a may provide, using a common CSI framework, a joint CSI report that is based on (e.g., that considers, that is generated as a function of) sub-BWP adaptation at the UE 115-a, NES spatial domain adaptation at the network entity 105-a, NES power domain adaptation at the network entity 105-a, or a combination thereof. Such a joint CSI report may provide the network entity 105-a with CSI for one or more adaptation techniques (e.g., sub-configuration 225) configured at the network entity 105-a and one or more (e.g., each) sub-BWP 215 configured at the UE 115-a.

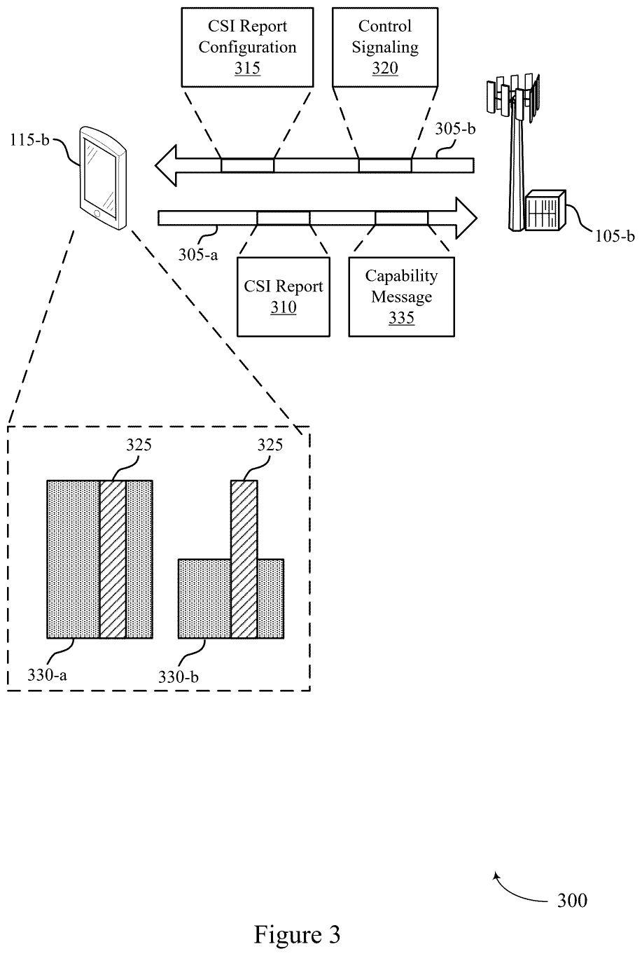

FIG. 3 shows an example of a signaling configuration 300 that supports light adaptation for reduced CSI configurations. The signaling configuration 300 may implement, or be implemented by, aspects of the wireless communication system 100 and the signaling configuration 200. For example, the UE 115-b and the network entity 105-b may be examples of corresponding devices described with reference to FIGS. 1 and 2. The UE 115-b and the network entity 105-b may communicate via a communication link 305-a and communication link 305-b, which may be examples of a cellular links (of one or more communication links 125). For example, the communication link 305-a may be an uplink (e.g., the UE 115-b and the network entity 105-b may communicate uplink signals via the communication link 305-a) and the communication link 305-b may be a downlink (e.g., the UE 115-b and the network entity 105-b may communicate downlink signals via the communication link 305-b).

In some examples, the UE 115-b may provide, using a common CSI framework, a CSI report 310 that is based on (e.g., that considers, that is a function of) sub-BWP adaptation at the UE 115-b, NES spatial domain adaptation at the network entity 105-b, or NES power domain adaptation at the network entity 105-b, or a combination thereof. The UE 115-b may generate the CSI report 310 based on a CSI report configuration 315 (e.g., indicated using first control signaling) and control signaling 320 (e.g., indicated using second control signaling). The CSI report configuration 315 may include one or more sub-configurations that configure the UE 115-b for CSI estimation in accordance with one or more respective adaptation techniques supported by the network entity 105-b (e.g., Type1 spatial domain adaptation, Type 2 spatial domain adaptation, power domain adaptation). For example, the CSI report configuration 315 may configure the UE 115-b with CSI-RS resources 325 that are scheduled in accordance with adaptation techniques supported by the network entity 105-b. The control signaling 320 may indicate one or more sub-BWPs 330 configured at the UE 115-b (e.g., a first sub-BWP 330-a and a second sub-BWP 330-b, sub-BWPs 215 of a BWP 210). In the example of FIG. 3, the first sub-BWP 330-a may be a wideband sub-BWP 330 and the second sub-BWP 330-b may be a narrowband sub-BWP 330 (e.g., having a bandwidth that is narrower than the first sub-BWP 330-a). The first sub-BWP 330-a may span a larger frequency (e.g., occupy more resource blocks) than the second sub-BWP 330-b.

The CSI report 310 may provide the network entity 105-b with CSI for one or more (e.g., each) adaptation techniques configured at the network entity 105-b and one or more (e.g., each) sub-BWPs 330 configured at the UE 115-b. For example, the UE 115-b may transmit the CSI report 310 including different sub-reports corresponding to different combinations of sub-BWPs 330 that are configured at the UE 115-b and adaptation techniques configured at the network entity 105-b. In some examples, the quantity of sub-reports included in the CSI report 310 may be based on a capability of the UE 115-b. For example, the UE 115-b may indicate, via capability information (e.g., a capability message 335), a quantity of sub-reports supported by the UE 115-b (e.g., a quantity of sub-reports that can be activated and shared between a sub-BWP 330 and a sub-configuration).

The UE 115-b may determine which sub-reports to include in the CSI report 310 based on an association (e.g., a correspondence, a linkage) between each sub-BWP 330 configured to the UE 115-b and each NES adaptation technique configured at the network entity 105-b. For example, if a given sub-BWP 330 is associated with a given NES adaptation technique (e.g., corresponding to the sub-BWP 330), the UE 115-b may monitor CSI-RS resources 325 for CSI-RSs corresponding to the NES adaptation technique and may transmit a sub-report corresponding to the CSI-RS. In some other examples, if a given sub-BWP 330 is not associated with a given NES adaptation technique, the UE 115-b may refrain from transmitting a sub-report corresponding to the sub-BWP 330 and the NES adaptation technique.

In some cases, an association (e.g., correspondence) may be indicated to the UE 115-b implicitly. For example, the UE 115-b may receive the CSI report configuration 315 including multiple sub-configurations that each further indicate one or more sub-BWPs 330 (e.g., states of the UE 115-b) corresponding to that sub-configuration. Additionally, or alternatively, the UE 115-b may receive signaling that configures CSI-RS resources 325 per sub-BWP 330. For example, the UE 115-b may receive separate signaling (e.g., separate reportFreqConfigurations) corresponding to a specific sub-BWP 330 that configures the UE 115-b with CSI-RS resources for that sub-BWP 330.

In some other examples, an association (e.g., correspondence) may be indicated to the UE 115-b explicitly via semi-static signaling (e.g., RRC signaling). For example, the UE 115-b may receive an indication of a table via RRC signaling that indicates correspondence between a sub-BWP 330 and an adaptation technique configured by the network entity 105-b. Table 1 below illustrates an example table showing correspondence between sub-BWPs 330 configured for the UE 115-b and adaptation techniques supported by the network entity 105-b.

TABLE 1
Association Between UE Sub-BWPs and
Network Adaptation Configurations

| | NW Antenna | NW Antenna | Power Domain |
|---|---|---|---|
| | Configuration 1 | Configuration 2 | Adaptation |
| Sub-BWP 1 | A | NA | NA |
| Sub-BWP 2 | A | A | NA |

In the example of Table 1, an “A” indicates an association (e.g., a correspondence) between a sub-BWP 330 and an NES adaptation technique (e.g., sub-configuration), and a “NA” indicates no association (e.g., no correspondence) between the sub-BWP 330 and the NES adaptation technique. In some examples, the UE 115-b may receive control signaling 320 (e.g., second control signaling) that indicates one or more sub-BWPs 330. For example, the control signaling 320 may activate or deactivate one or more sub-BWPs 330. Additionally, or alternatively, the control signaling 320 that indicates the one or more sub-BWPs 330 may also indicate one or more sub-configurations of the CSI report configuration 315 that correspond to the one or more sub-BWPs 330.

In some examples, the control signaling 320 may be a MAC-CE that activates or deactivates sub-BWPs 330. Implementation of such a MAC-CE may enable finer (e.g., separate, more granular) activation of sub-BWPs 330 from the rest of the CSI report configuration 315 (e.g., to fall back to NES-type CSI reporting). In some other examples, the control signaling 320 may be a DCI that indicates for the UE 115-b to switch sub-BWPs 330. In such cases, the DCI may deactivate a subset of the sub-configurations for the network entity 105-b (e.g., a subset of CSI-RS configurations). For example, if the UE 115-b switches sub-BWPs 330 (e.g., from a first sub-BWP 330-a to a second sub-BWP 330-b), a subset L of (e.g., less than all of) the total N sub-configurations for the network entity 105-b may be valid. For example, the second sub-BWP 330-b (e.g., corresponding to a low power state of the UE 115-b) may be associated with (e.g., correspond to) high power states of the network entity 105-b and may not be associated with low power states of the network entity 105-b. If the UE 115-b switches to the second sub-BWP 330-b, the sub-configurations corresponding to a high power state of the network entity 105-b may be valid, whereas the sub-configurations corresponding to a low power state of the network entity 105-b may be invalid.

In some examples, the CSI report configuration 315 may configure the UE 115-b with CSI-RS resources 325 that fall outside (e.g., in the frequency domain) of a sub-BWP 330. For example, the UE 115-b may be configured with CSI-RS resources 325 that are within the first sub-BWP 330-a. However, because the second sub-BWP 330-b is associated with (e.g., spans, occupies) fewer resource blocks (e.g., in the frequency domain) than the first sub-BWP 330-a, the CSI-RS resources 325 may fall outside of the second sub-BWP 330-b. If the UE 115-b switches to the second sub-BWP 330-b, the UE 115-b may ignore a portion of the CSI report configuration 315 (e.g., a portion of the CSI-RS resources 325) that are outside of the second sub-BWP 330-b when generating the CSI report 310.

The UE 115-b may perform CSI operations using one or more CSI processing units (e.g., of the UE 115-b). The quantity of CSI processing units may be based on a quantity of sub-configurations included in the CSI report configuration 315 and a respective quantity of channel measurement resources corresponding to each sub-configuration. For example, the UE 115-b may count a quantity of CSI processing units based on which sub-configurations are used for CSI measurement and the respective resources corresponding to such sub-configurations.

In some examples, by generating the CSI report 310 based on associations between (e.g., respective correspondence between) sub-BWPs 330 and NES adaptation techniques, the described techniques can be used to extend a CSI reporting framework to support sub-reports based on sub-BWPs 330 configured for light adaptation in addition to NES antenna adaptation using a single CSI reporting configuration, which may reduce signaling overhead and latency.

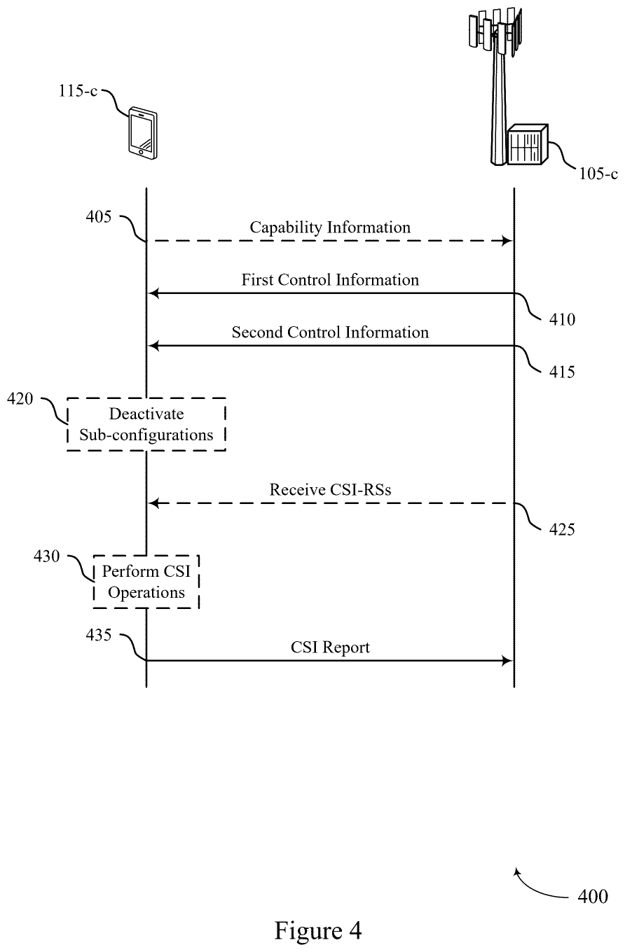

FIG. 4 shows an example of a process flow 400 that supports light adaptation for reduced CSI configurations. In some cases, the process flow 400 may implement or be implemented by aspects of a wireless communications system 100, a signaling configuration 200, a signaling configuration 300, or any combination thereof. For example, the process flow 400 may include a UE 115-c and a network entity 105-c, which may be examples of corresponding devices as described herein. In the following description of the process flow 400, the operations between the UE 115-c and the network entity 105-c may be communicated in a different order than the example order shown, or the operations performed by the UE 115-c and the network entity 105-c may be performed in different orders or at different times. Some operations may also be omitted from the process flow 400, and other operations may be added to the process flow 400.

At 405, in some examples, the UE 115-c may transmit capability information, which may be received by the network entity 105-c. In some examples, the capability information of 405 may indicate a quantity of sub-reports (e.g., of a CSI reporting configuration) supported by the UE 115-c. Such an indication may enable the network entity 105-c to understand which features of light adaptation for reduced CSI configurations are supported, and how such features may be implemented, such as which of a set of sub-reports may be reported by the UE 115-c.

At 410, the network entity 105-c may transmit first control information that indicates a CSI report configuration corresponding to a BWP (e.g., a BWP 210), which may be received by the UE 115-c. The CSI report configuration of 410 may refer to an overall reporting configuration, from which the UE 115-c may infer aspects of sub-reporting based on other configurations (e.g., without subsequent explicit indications of sub-reports, inferred based on configured or activated sub-BWP(s) 215 or sub-BWP(s) 330). The CSI report configuration may be associated with a first power consumption, and one or more sub-configurations of the CSI report configuration may be associated with a second power consumption that is less than the first power consumption. Accordingly, a sub-configuration may be implemented to reduce power consumption.

In some examples, the CSI report configuration of 410 includes a set of multiple sub-reports, each corresponding to a respective sub-BWP (e.g., sub-BWP 215, sub-BWP 330) of the BWP. In some other examples, the CSI report configuration of 410 may indicate multiple sub-configurations of the CSI report configuration, each corresponding to one or more sub-BWPs of the BWP. The BWP may correspond to (e.g., include, span) multiple resource blocks in the frequency domain and the sub-BWP may correspond to a subset of fewer than all of the multiple resource blocks in the frequency domain.

In some examples, to receive the CSI report configuration, the UE 115-c may receive RRC signaling that indicates the CSI report configuration corresponding to the BWP. Such techniques may be implemented as part of a connection establishment (e.g., to establish a communication link 125), and may be associated with communicating a relatively static configuration (e.g., reserving more-dynamic signaling, such as MAC signaling or DCI, for other more-dynamic configuration).

At 415, the network entity 105-c may transmit second control information (e.g., after transmitting the first control information) that indicates a sub-BWP of the BWP, which may be received by the UE 115-c (e.g., after receiving the first control information). The second control information of 415 may not include (e.g., may omit, may be free from) an explicit indication of sub-reporting or sub-configurations, which may be associated with lower signaling overhead than other techniques that implement such explicit indications. In other words, by communicating the second control information at 415, communication of another instance of first control information (e.g., another full CSI report configuration) may be avoided.

In some examples, the second control information (e.g., the transmission of the second control information, an indicator of the second control information) may correspond to an antenna configuration of the network entity 105-c (e.g., an antenna adaptation at the network entity 105-c, a spatial domain adaptation at the network entity 105-c, an antenna array configuration at the network entity 105-c, a power adaptation at the network entity 105-c), which may enable aspects of sub-reporting by the UE 115-c in accordance with the antenna configuration of the network entity 105-c.

In some examples, the second control information of 415 may indicate one or more sub-configurations of the CSI report configuration indicated by the first control information of 410. In some examples, the UE 115-c receiving the second control information at 415 may be based on capability information transmitted at 405 (e.g., where applicable). In some other examples, the second control information of 415 may be communicated using a MAC-CE that indicates the sub-BWP, or DCI of a PDCCH that indicates the sub-BWP. Using a MAC-CE or DCI may support relatively more dynamic configuration of sub-BWPs (e.g., more dynamic than RRC signaling that may convey the first control information of 410, more adaptable UE-specific sub-configurations) and corresponding inferences by the UE 115-c for the described sub-reporting.

At 420, in some examples, the UE 115-c may deactivate (e.g., in response to the second control information of 415) one or more of the sub-configurations of the CSI report configuration indicated at 410, excluding the sub-configuration (e.g., of the sub-BWP indicated in the second control information of 415) based at least in part on the second control information of 415. Such deactivation of sub-configurations may support power savings or reduced processor utilization, among other benefits.

At 425, in some examples, the UE 115-c may receive (e.g., monitor, measure), based on the second control information of 415, a set of one or more CSI-RSs using a subset of the CSI-RS resources, the subset of the CSI-RS resources corresponding to the sub-BWP indicated by the second control information of 415. Such techniques may support monitoring fewer than all of the configured CSI-RS resources for the BWP, which may support power savings or reduced processor utilization, among other benefits.

At 430, in some examples, the UE 115-c may perform one or more CSI operations in accordance with a quantity of CSI processing units of the UE 115-c, the quantity of CSI processing units based on a quantity of sub-configurations of the CSI report configuration and a respective quantity of channel measurement resources corresponding to each sub-configuration. Such techniques may support fewer than all of the CSI processing units of the UE 115-c, which may support power savings or reduced processor utilization, among other benefits.

At 435, the UE 115-c may transmit (e.g., based on receiving the first control information and the second control information, such as in response to or as a function of such control information) a CSI report in accordance with a sub-configuration of the CSI report configuration corresponding to the BWP, the sub-configuration corresponding to the sub-BWP of the BWP. The CSI report of 435 may be received by the network entity 105-c, which may perform communications in accordance with the results of the report (e.g., and in accordance with a configuration of the network entity 105-c, such as an adaptation of the network entity 105-c).

In some examples, the UE 115-c may transmit the CSI report of 435 based on receiving the set of one or more CSI-RSs using the subset of the CSI-RS resources (e.g., at 425). In some examples, the CSI report of 435 may be a sub-report of the plurality of sub-reports that corresponds to the sub-BWP (e.g., based on the second control information of 415, as a function of the second control information of 415). In some examples, the CSI report of 435 may be generated at the UE 115-c based on ignoring a portion of the CSI report configuration (e.g., as indicated in the first control information of 410) corresponding to one or more frequency bands outside the sub-BWP that is indicated in the second control information of 415.

Thus, in accordance with these and other examples, a UE 115 may receive a CSI report configuration (e.g., in first control information) indicating multiple reporting sub-configurations which, in some examples, may each correspond to a respective type of adaptation technique supported by a network entity 105. The UE 115 may receive additional signaling (e.g., second control information) activating one of a plurality of sub-BWPs of a bandwidth for evaluating CSI. In some examples, the UE 115 may receive one or more CSI-RSs via the activated sub-BWP for evaluating CSI. The UE 115 may transmit a joint CSI report that includes one or more sub-reports based on the CSI report configuration and in accordance with the activated sub-BWP. In some examples, the UE 115 may determine which sub-reports to include in the joint CSI report based on an association (e.g., a correspondence, a configuration, an inference) between the activated sub-BWP and each reporting sub-configuration included in the CSI reporting configuration. For example, fewer than all of the reporting sub-configurations may be considered valid for the activated sub-BWP of the UE 115. Accordingly, the joint CSI report may include sub-reports corresponding to the valid reporting sub-configurations for the activated sub-BWP, which may be implemented in accordance with reduced configuration or signaling overhead. By generating joint CSI reports based on associations between UE sub-BWPs and NES adaptation techniques, the described techniques can be used to extend a CSI reporting framework to support sub-reports based on sub-BWPs configured for UE light adaptation in addition to network entity antenna adaptation using a single CSI reporting configuration, which may reduce signaling overhead and latency.

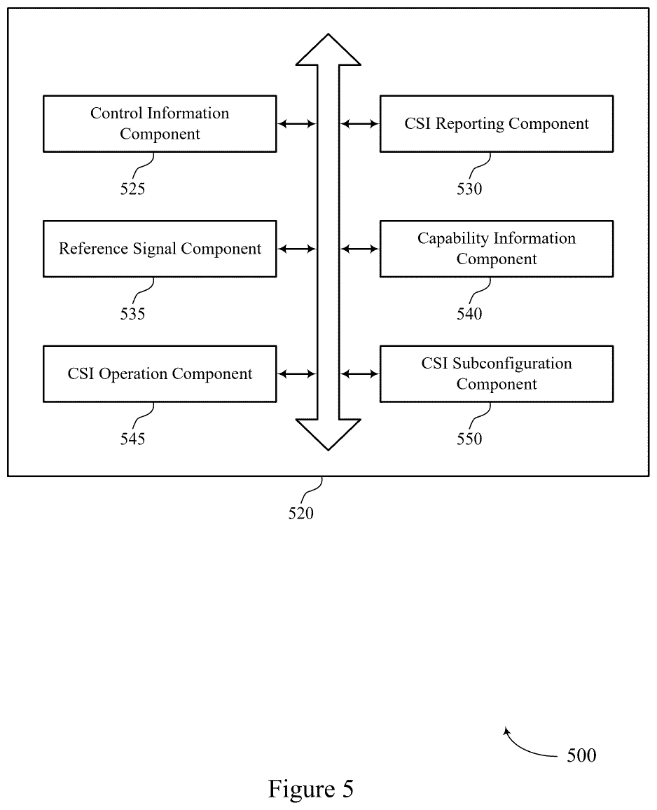

FIG. 5 shows an example 500 of a processing system 520 that supports light adaptation for reduced CSI configurations. A processing system 520 may be an example of a processing system 140 (such as of a UE 115) and may include a control information component 525, a CSI reporting component 530, a reference signal component 535, a capability information component 540, a CSI operation component 545, a CSI sub-configuration component 550, or any combination thereof. A processing system 520, or various component thereof, may be an example of means for performing (such as a means for causing a UE 115 to perform) various techniques described herein.

The control information component 525 may be configured to cause a UE 115 to receive first control information that indicates a CSI report configuration corresponding to a bandwidth part. In some examples, the control information component 525 may be configured to cause the UE 115 to receive second control information, after receiving the first control information, that indicates a sub-bandwidth part of the bandwidth part. The CSI reporting component 530 may be configured to cause the UE 115 to transmit, based on receiving the first control information and the second control information, a CSI report in accordance with a sub-configuration of the CSI report configuration corresponding to the bandwidth part, the sub-configuration corresponding to the sub-bandwidth part of the bandwidth part.

In some examples, the CSI report configuration corresponds to a set of CSI-RS resources corresponding to the bandwidth part. In some such examples, the reference signal component 535 may be configured to cause the UE 115 to receive, based on the second control information, a set of one or more CSI-RSs using a subset of the CSI-RS resources, the subset of the CSI-RS resources corresponding to the sub-bandwidth part, and the CSI reporting component 530 may be configured to cause the UE 115 to transmit the CSI report based on receiving the set of one or more CSI-RSs using the subset of the CSI-RS resources.

In some examples, the CSI report configuration includes a set of multiple sub-reports each corresponding to a respective sub-bandwidth part of the bandwidth part, and the CSI report is a sub-report of the set of multiple sub-reports that corresponds to the sub-bandwidth part based on the second control information that indicates the sub-bandwidth part.

In some examples, the second control information indicates one or more sub-configurations of the CSI report configuration that correspond to the sub-bandwidth part.

In some examples, the second control information corresponds to an antenna configuration of a network entity.

In some examples, the CSI report configuration indicates a set of multiple sub-configurations of the CSI report configuration, each of the set of multiple sub-configurations corresponding to one or more sub-bandwidth parts of the bandwidth part.

In some examples, the CSI sub-configuration component 550 may be configured to cause the UE 115 to deactivate one or more of the set of multiple sub-configurations of the CSI report configuration excluding the sub-configuration based on the second control information.

In some examples, to support receiving the first control information, the control information component 525 may be configured to cause the UE 115 to receive RRC signaling that indicates the CSI report configuration corresponding to the bandwidth part.

In some examples, to support receiving the second control information, the control information component 525 may be configured to cause the UE 115 to receive a MAC-CE that indicates the sub-bandwidth part.

In some examples, to support receiving the second control information, the control information component 525 may be configured to cause the UE 115 to receive DCI of a PDCCH that indicates the sub-bandwidth part.

In some examples, the capability information component 540 may be configured to cause the UE 115 to transmit capability information that indicates a quantity of sub-reports supported by the UE, and receiving the second control information may be based on the capability information.

In some examples, the CSI operation component 545 may be configured to cause the UE 115 to perform one or more CSI operations in accordance with a quantity of CSI processing units of the UE, the quantity of CSI processing units based on a quantity of sub-configurations of the CSI report configuration and a respective quantity of channel measurement resources corresponding to each sub-configuration.

In some examples, the CSI report is generated based on ignoring a portion of the CSI report configuration corresponding to one or more frequency bands outside the sub-bandwidth part.

In some examples, the CSI report configuration is associated with a first power consumption, and the sub-configuration of the CSI report configuration is associated with a second power consumption that is less than the first power consumption.

In some examples, the bandwidth part corresponds to a set of multiple resource blocks in a frequency domain, and the sub-bandwidth part corresponds to a subset of fewer than all of the set of multiple resource blocks in the frequency domain.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for reduced latency, improved user experience related to reduced processing, reduced power consumption, and more efficient utilization of communication resources, among other benefits.

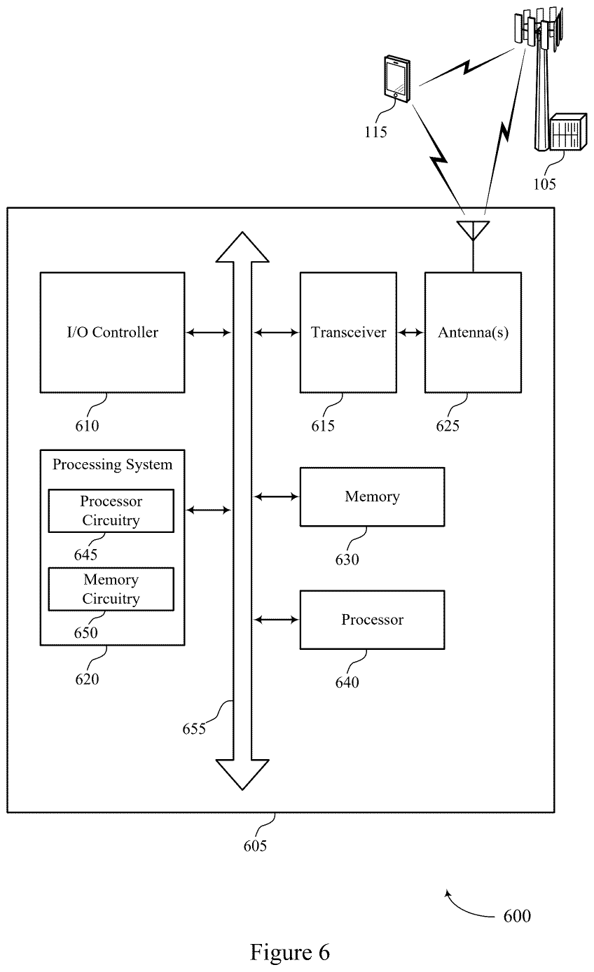

FIG. 6 shows an example of a system 600 including a device 605 that supports light adaptation for reduced CSI configurations. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support light adaptation for reduced CSI configurations. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for reduced latency, improved user experience related to reduced processing, reduced power consumption, and more efficient utilization of communication resources.

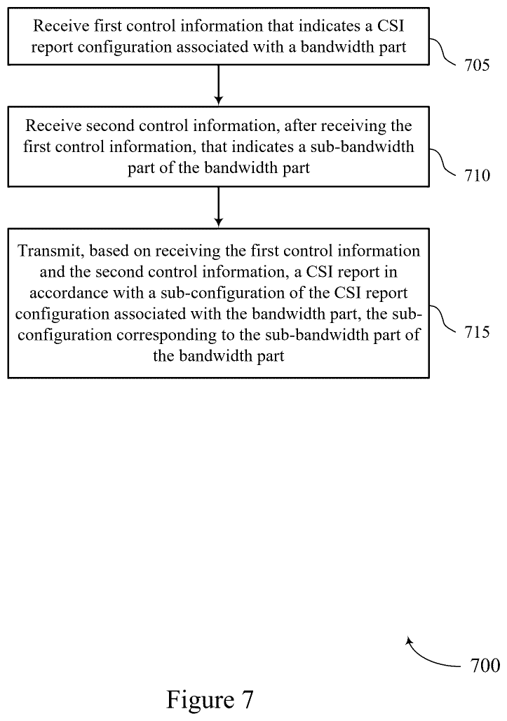

FIG. 7 shows an example of a method 700 that supports light adaptation for reduced CSI configurations. Operations of the method 700 may be performed by a UE or its components (such as using a processing system configured to cause the UE 115 to perform one or more of the operations) as described herein.

At 705, the method may include receiving first control information that indicates a CSI report configuration corresponding to a bandwidth part. In some examples, aspects of the operations of 705 may be performed by a control information component 525.

At 710, the method may include receiving second control information, after receiving the first control information, that indicates a sub-bandwidth part of the bandwidth part. In some examples, aspects of the operations of 710 may be performed by a control information component 525.

At 715, the method may include transmitting, based on receiving the first control information and the second control information, a CSI report in accordance with a sub-configuration of the CSI report configuration corresponding to the bandwidth part, the sub-configuration corresponding to the sub-bandwidth part of the bandwidth part. In some examples, aspects of the operations of 715 may be performed by a CSI reporting component 530.

Implementation examples are described in the following numbered clauses:

Aspect 1: A method for wireless communications at a UE, comprising: receiving first control information that indicates a CSI report configuration corresponding to a bandwidth part; receiving second control information, after receiving the first control information, that indicates a sub-bandwidth part of the bandwidth part; and transmitting, based at least in part on receiving the first control information and the second control information, a CSI report in accordance with a sub-configuration of the CSI report configuration corresponding to the bandwidth part, the sub-configuration corresponding to the sub-bandwidth part of the bandwidth part.

Aspect 2: The method of aspect 1, wherein the CSI report configuration corresponds to a set of CSI-RS resources corresponding to the bandwidth part, the method further comprising: receiving, based at least in part on the second control information, a set of one or more CSI-RSs using a subset of the CSI-RS resources, the subset of the CSI-RS resources corresponding to the sub-bandwidth part; and transmitting the CSI report based at least in part on receiving the set of one or more CSI-RSs using the subset of the CSI-RS resources.

Aspect 3: The method of any of aspects 1 through 2, wherein the CSI report configuration comprises a plurality of sub-reports each corresponding to a respective sub-bandwidth part of the bandwidth part; and the CSI report is a sub-report of the plurality of sub-reports that corresponds to the sub-bandwidth part based at least in part on the second control information that indicates the sub-bandwidth part.

Aspect 4: The method of any of aspects 1 through 3, wherein the second control information indicates one or more sub-configurations of the CSI report configuration corresponding to the sub-bandwidth part.

Aspect 5: The method of any of aspects 1 through 4, wherein the second control information corresponds to an antenna configuration of a network entity.

Aspect 6: The method of any of aspects 1 through 5, wherein the CSI report configuration indicates a plurality of sub-configurations of the CSI report configuration, each of the plurality of sub-configurations corresponding to one or more sub-bandwidth parts of the bandwidth part.

Aspect 7: The method of aspect 6, further comprising: deactivating one or more of the plurality of sub-configurations of the CSI report configuration excluding the sub-configuration based at least in part on the second control information.

Aspect 8: The method of any of aspects 1 through 7, wherein receiving the first control information comprises: receiving RRC signaling that indicates the CSI report configuration corresponding to the bandwidth part.

Aspect 9: The method of any of aspects 1 through 8, wherein receiving the second control information comprises: receiving a medium access control (MAC) control element that indicates the sub-bandwidth part.

Aspect 10: The method of any of aspects 1 through 9, wherein receiving the second control information comprises: receiving DCI of a PDCCH that indicates the sub-bandwidth part.

Aspect 11: The method of any of aspects 1 through 10, further comprising: transmitting capability information that indicates a quantity of sub-reports supported by the UE, wherein receiving the second control information is based at least in part on the capability information.

Aspect 12: The method of any of aspects 1 through 11, further comprising: performing one or more CSI operations in accordance with a quantity of CSI processing units of the UE, the quantity of CSI processing units based at least in part on a quantity of sub-configurations of the CSI report configuration and a respective quantity of channel measurement resources corresponding to each sub-configuration.

Aspect 13: The method of any of aspects 1 through 12, wherein the CSI report is generated based at least in part on ignoring a portion of the CSI report configuration corresponding to one or more frequency bands outside the sub-bandwidth part.

Aspect 14: The method of any of aspects 1 through 13, wherein the CSI report configuration is associated with a first power consumption; and the sub-configuration of the CSI report configuration is associated with a second power consumption that is less than the first power consumption.

Aspect 15: The method of any of aspects 1 through 14, wherein the bandwidth part corresponds to a plurality of resource blocks in a frequency domain; and the sub-bandwidth part corresponds to with a subset of fewer than all of the plurality of resource blocks in the frequency domain.

Aspect 16: A UE for wireless communications, comprising a processing system that includes processor circuitry and memory circuitry that stores code, the processing system configured to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive first control information that indicates a channel state information (CSI) report configuration corresponding to a bandwidth part;
receive second control information, after reception of the first control information, that indicates a sub-bandwidth part of the bandwidth part; and
transmit, based at least in part on reception of the first control information and the second control information, a CSI report in accordance with a sub-configuration of the CSI report configuration corresponding to the bandwidth part, the sub-configuration corresponding to the sub-bandwidth part of the bandwidth part.

2. The UE of claim 1, wherein the CSI report configuration corresponds to a set of channel state information reference signal (CSI-RS) resources corresponding to the bandwidth part, and the processing system is further configured to cause the UE to:
receive, based at least in part on the second control information, a set of one or more CSI-RSs using a subset of the CSI-RS resources, the subset of the CSI-RS resources corresponding to the sub-bandwidth part; and
transmit the CSI report based at least in part on reception of the set of one or more CSI-RSs using the subset of the CSI-RS resources.

3. The UE of claim 1, wherein:
the CSI report configuration comprises a plurality of sub-reports each corresponding to a respective sub-bandwidth part of the bandwidth part; and
the CSI report is a sub-report of the plurality of sub-reports that corresponds to the sub-bandwidth part based at least in part on the second control information that indicates the sub-bandwidth part.

4. The UE of claim 1, wherein the second control information indicates one or more sub-configurations of the CSI report configuration that correspond to the sub-bandwidth part.

5. The UE of claim 1, wherein the second control information corresponds to an antenna configuration of a network entity.

6. The UE of claim 1, wherein the CSI report configuration indicates a plurality of sub-configurations of the CSI report configuration, each of the plurality of sub-configurations corresponding to one or more sub-bandwidth parts of the bandwidth part.

7. The UE of claim 6, wherein the processing system is further configured to cause the UE to:
deactivate one or more of the plurality of sub-configurations of the CSI report configuration excluding the sub-configuration based at least in part on the second control information.

8. The UE of claim 1, wherein, to receive the first control information, the processing system is configured to cause the UE to:
receive radio resource control (RRC) signaling that indicates the CSI report configuration corresponding to the bandwidth part.

9. The UE of claim 1, wherein, to receive the second control information, the processing system is configured to cause the UE to:
receive a medium access control (MAC) control element that indicates the sub-bandwidth part.

10. The UE of claim 1, wherein, to receive the second control information, the processing system is configured to cause the UE to:
receive downlink control information (DCI) of a physical downlink control channel (PDCCH) that indicates the sub-bandwidth part.

11. The UE of claim 1, wherein the processing system is further configured to cause the UE to:
transmit capability information that indicates a quantity of sub-reports supported by the UE, wherein reception of the second control information is based at least in part on the capability information.

12. The UE of claim 1, wherein the processing system is further configured to cause the UE to:
perform one or more CSI operations in accordance with a quantity of CSI processing units of the UE, the quantity of CSI processing units based at least in part on a quantity of sub-configurations of the CSI report configuration and a respective quantity of channel measurement resources corresponding to each sub-configuration.

13. The UE of claim 1, wherein the CSI report is generated based at least in part on ignoring a portion of the CSI report configuration corresponding to one or more frequency bands outside the sub-bandwidth part.

14. The UE of claim 1, wherein:
the CSI report configuration is associated with a first power consumption; and
the sub-configuration of the CSI report configuration is associated with a second power consumption that is less than the first power consumption.

15. The UE of claim 1, wherein:
the bandwidth part corresponds to a plurality of resource blocks in a frequency domain; and
the sub-bandwidth part corresponds to a subset of fewer than all of the plurality of resource blocks in the frequency domain.

16. A method for wireless communications at a user equipment (UE), comprising:
receiving first control information that indicates a channel state information (CSI) report configuration corresponding to a bandwidth part;
receiving second control information, after receiving the first control information, that indicates a sub-bandwidth part of the bandwidth part; and
transmitting, based at least in part on receiving the first control information and the second control information, a CSI report in accordance with a sub-configuration of the CSI report configuration corresponding to the bandwidth part, the sub-configuration corresponding to the sub-bandwidth part of the bandwidth part.

17. The method of claim 16, wherein the CSI report configuration corresponds to a set of channel state information reference signal (CSI-RS) resources corresponding to the bandwidth part, the method further comprising:
receiving, based at least in part on the second control information, a set of one or more CSI-RSs using a subset of the CSI-RS resources, the subset of the CSI-RS resources corresponding to the sub-bandwidth part; and
transmitting the CSI report based at least in part on receiving the set of one or more CSI-RSs using the subset of the CSI-RS resources.

18. The method of claim 16, wherein:
the CSI report configuration comprises a plurality of sub-reports each corresponding to a respective sub-bandwidth part of the bandwidth part; and
the CSI report is a sub-report of the plurality of sub-reports that corresponds to the sub-bandwidth part based at least in part on the second control information that indicates the sub-bandwidth part.

19. The method of claim 16, wherein the second control information indicates one or more sub-configurations of the CSI report configuration that correspond to the sub-bandwidth part.

20. A non-transitory computer-readable medium storing code for wireless communications at a user equipment, the code comprising instructions executable by one or more processors to:
receive first control information that indicates a channel state information (CSI) report configuration corresponding to a bandwidth part;
receive second control information, after reception of the first control information, that indicates a sub-bandwidth part of the bandwidth part; and
transmit, based at least in part on reception of the first control information and the second control information, a CSI report in accordance with a sub-configuration of the CSI report configuration corresponding to the bandwidth part, the sub-configuration corresponding to the sub-bandwidth part of the bandwidth part.
